(19) United States
(12) Patent Application Publication
(10) Pub. No.: US 2002/0049720 A1
(43) Pub. Date: Apr. 25, 2002

(54) System and method of data mining

(75) Inventor: Richard Q. Schmidt, Huntington, NY (US)

Correspondence Address: OSTROLENK FABER GERB & SOFFEN, 1180 AVENUE OF THE AMERICAS, NEW YORK, NY, 100368403

(73) Assignee: Chase Manhattan Bank

(21) Appl. No.: 09/854,337

(22) Filed: May 11, 2001

Related U.S. Application Data
(60) Provisional application No. 60/203,216, filed on May 11, 2000.

(51) Int. Cl. G06F 17/30

(52) U.S. Cl. 707/1

(57) ABSTRACT

A system and method for mining data for intelligent patterns uses logical techniques to isolate unique patterns and reduce the patterns to a consistent set of rules representing the data. The system and method eliminates attributes in the patterns that do not contribute to an associated conclusion and are deemed irrelevant. This approach does not splinter significant patterns within the data, as may occur with statistical approaches. In addition, the system and method identifies areas of incomplete data that are not recognized in other methods.

This application is based on and claims benefit of provisional application number 60/203,216, filed May 11, 2000, to which a claim of priority is made.

### BACKGROUND OF THE INVENTION

1. Field of the Invention

The present invention relates generally to a method of data mining. More specifically, the present invention is related to a method of obtaining rules describing pattern information in a data set.

2. Description of the Related Prior Art

Data mining takes advantage of the potential intelligence contained in the vast amounts of data collected by businesses when interacting with customers. The data generally contains patterns that can indicate, for example, when it is most appropriate to contact a particular customer for a specific purpose. A business may timely offer a customer a product that has been purchased in the past, or draw attention to additional products that the customer may be interested in purchasing. Data mining has the potential to improve the quality of interactions between businesses and customers. In addition, data mining can assist in detection of fraud while providing other advantages to business operations, such as increased efficiency. It is the object of data mining to extract fact patterns from a data set, to associate the fact patterns with potential conclusions and to produce an intelligent result based on the patterns embedded in the data.

Currently available commercial software generally relies on data mining methods based on the Induction of Decision Trees (ID3)) or Chi Squared Automatic Interaction Detection (CHAID) algorithms. These algorithms use statistical methods to determine which attributes of the data should be the focus of pattern extraction to obtain significant results. However, these algorithms are generally based on a linear analysis approach, while the data is generally non-linear in nature. The application of these linear algorithms to non-linear data can typically only succeed if the data is divided into smaller sets that approximate linear models. This approach may compromise the integrity of the original data patterns and make extraction of significant data patterns problematic.

Neural networks and case based reasoning algorithms may also be used in data mining processes. Known as machine learning algorithms, neural nets and case based reasoning algorithms are exposed to a number of patterns to “teach” the proper conclusion given a particular data pattern.

However, neural networks have the disadvantage of obscuring the patterns that are discovered in the data. A neural network simply provides conclusions about what known neural network patterns most closely match newly presented data. The inability to view the discovered patterns limits the usefulness of this technique because there is no means for determining the accuracy of the resulting conclusions other than by actual testing. In addition, the neural network must be “taught” by being exposed to a number of patterns. However, in the course of teaching the neural network as much as possible about patterns in data to which it is exposed, over-training becomes a problem. An over-trained neural network may have irrelevant data attributes included in the conclusions, which leads to poor recognition of relevant data patterns with which the neural network is presented.

Case based reasoning also has a learning phase in which a known pattern is compared with slightly different but similar patterns to produce associations with a particular data case. When presented with new data patterns, the algorithm evaluates which group of similar learned patterns most closely matches the new data case. As with CHAID, this method also suffers from a dependence on the statistical distribution of the data used to train the system, resulting in a system that may not discover all relevant patterns.

The goal of data mining is to obtain a certain level of intelligence regarding customer activity based on previous activity patterns present in a data set related to customer activity. Intelligence can be defined as the association of a pattern of facts with a conclusion. The data to be mined is usually organized as records containing fields for each of the fact items and an associated conclusion. Fact value patterns define situations or contexts within which fact values are interpreted. Some fact values in a given pattern may provide the context in which the remaining fact values in the pattern are interpreted. Therefore, fact values given an interpretation in one context may receive a different interpretation in another context. As an example, a person approached by stranger at night on an isolated street would probably be more wary than if approached by the same person during the day or with a policeman standing nearby. This complicates the extraction of intelligence from data, in that individual facts cannot be directly associated with conclusions. Instead, fact values must be taken in context when associations are made.

Each field in a record can represent a fact with a number of possible values. The permutations that can be formed from the number of possible associations between the various fact items is N1 * N2 * N3 * . . . * Ni * . . . * Nn, where each Ni represents the number of values that the fact item can assume. When there are a large number of fact items, the number of possible associations between the fact items, or patterns, can be very large. Most often, however, all possible combinations of fact item values are not represented in the data. As a practical matter, the number of conclusions or actions associated with the fact item patterns is normally much smaller. A large number of data records are normally required to ensure that the data correctly represents true causality or associative quality between all the fact items and the conclusions. The large number of theoretically possible patterns, and the large number of data records makes it very difficult to find patterns that are strongly associated with a particular conclusion or action. In addition, even when the amount of data is large, all possible combinations of values for fact items 1 through n may still not be represented. As a result, some of the theoretically possible patterns may not be found in the patterns represented by data.

Statistical methods have been used to determine which fact item (usually referred to as an attribute) has the most influence on a particular conclusion. A typical statistical method divides the data into two record groups according to a value for a particular fact item. Each record group will have a different conclusion, or action associated with the grouping of values related to the conclusion or action in the data for that group. Each subgroup is again divided according to the value of a particular fact item. The process continuing until no further division is statistically significant, or at some arbitrary level of divisions. In dividing the data at each step, evidence of certain patterns can be split among the two groups, reducing the chance that the pattern will show statistical significance, and hence be discovered.

Once the division of the data is complete, it is possible to find patterns in the data that show significant association with conclusions in the data. Normally, the number of actual patterns, although larger than the number of conclusions, is a small fraction of the possible number of patterns. A greater number of patterns with respect to conclusions or actions may indicate the existence of irrelevant fact items or redundancies for some or all of the conclusions. Irrelevant fact items may be omitted from a pattern without affecting the truth of the association between the remaining relevant fact items and the respective conclusion. A pattern with omitted fact items thus becomes more generalized, representing more than one of the possible patterns determined by all fact items. However, when a decision of irrelevancy is made based on statistical methods, patterns which occur infrequently may be excluded as being statistically irrelevant. In addition, an infrequently occurring pattern may have diminished relevancy when the data is divided into groups based on more frequently occurring patterns. However, if a statistic based effort is made to collect and examine patterns which occur infrequently, some patterns may be included that indicate incorrect conclusions. Inclusion of these incorrect patterns is a condition known as over-fitting of the data.

Another difficulty in this field is that examples of all conclusions of interest may not be present in the data. Since statistical methods rely on examples of patterns and their associated conclusions to discover data patterns, they can offer no help with this problem.

### SUMMARY OF THE INVENTION

Accordingly, it is an object of the invention to provide a systematic method for discovery of all patterns in data that reflect the essence of information or intelligence represented by that data.

A further object is to surpass the performance of statistical based data mining methods by detecting patterns that have small statistical support.

A further object is to determine the factors in the data that are relevant to the outcomes or conclusions defined by the data.

A further object of the invention is to provide a minimal set of patterns that represent the intelligence or knowledge represented by the data.

A further object of the invention is to indicate missing patterns and pattern overlap due to incomplete data for defining the domain of knowledge.

The present invention uses logic to directly determine the factors or attributes that are relevant or significant to the associated conclusions or actions represented in a set of data. A method according to the present invention reveals all significant patterns in the data. The method permits the determination of a minimal set of patterns for the knowledge domain represented by the data. The method also removes irrelevant attributes from the patterns identified in the data. The method allows the determination of all the possible patterns within the constraints imposed by the data. The present invention thus provides a method for detecting and reporting patterns needed to completely cover all relevant outcomes.

The method begins by grouping examples with identical attribute patterns and establishing the conclusion that occurs most often for that group. Conclusions that occur least often are treated as erroneous data. The grouping of examples reduces the data size while removing occasional erroneous data. Treating each group as one record reduces the data set to a smaller number of records. These records are in the form of an attribute set and an associated conclusion, referred to as rules. The rules are examined one at a time, comparing the attribute values in a rule having one conclusion to the values of the same attributes for all the rules containing a different conclusion. If the values match, the attribute is declared irrelevant and removed from the first rule. Some of the attributes that are declared irrelevant in one comparison are sometimes relevant for a comparison with a different rule and must be kept to distinguish between the two rules. The attributes that are found to be relevant for at least one comparison, although previously declared irrelevant, are declared as a new set of relevant attributes. Rules with the same conclusion are not compared since they shed no new insight as to the relevance of the attributes.

After all the rules have been compared to all the rules with a differing conclusion, and the relevant sets of attributes for each rule have been identified, the records are expanded into canonical form. Rules having the same conclusion are then compared to eliminate redundant patterns. The result is a minimal set of rules that completely encompass all the possible combinations of the attribute values with no overlap between records of different conclusions, unless the data is insufficient to make such a distinction possible. The method allows for manual correction of the rules in the case of insufficient data, if there is reason to believe proper correction can be made.

Other features and advantages of the present invention will become apparent from the following description of the invention that refers to the accompanying drawings.

### BRIEF DESCRIPTION OF THE DRAWINGS

FIG. 1 describes the steps of the data mining method.

FIG. 2 describes the steps of formatting data.

FIG. 3 describes the steps of finding all unique patterns.

FIGS. 4(a), (b) describe the steps of finding relevant attributes.

FIG. 5 describes the steps of removing redundant rules.

FIG. 6 describes the steps of expanding rules into canonical form.

FIG. 7 shows a group of N data records with attribute lists and associated conclusions.

FIG. 8 shows a canonical expansion from a relevant attribute rule.

### DETAILED DESCRIPTION OF THE PREFERRED EMBODIMENTS

The basic assumption for the method of data mining disclosed herein is that all data records are essentially rules of intelligence if they contain 1) attributes describing a situation, and 2) an appropriate conclusion or action to be taken for that situation. It is also assumed that the majority of these data records contain correct conclusions or actions associated with the set of attribute values. That is to say, the conclusion for each particular set of attribute values is a correct conclusion in the general case. Although errors in the data records may occur in practice, a set of rules will be developed based only on correct, or majority conclusions for a given data pattern. The data records, often referred to as cases, represent information related to situations of everyday life recorded in a physical medium. A machine can draw conclusions and build a knowledge base from this information contained in the data records.

A number of other assumptions are made for the method of the present invention to perform properly. The method begins with access to a set of records containing attributes related to a given situation.

The present invention presumes that all attributes are discretely valued. Continuously valued attributes therefore must be converted into discrete values by any reasonable method.

Patterns are then sought within the record set. A pattern is generally recognized as a set of reoccurring attribute values associated with a particular conclusion. It is possible to have errors in the data that produce conflicting conclusions or actions for the same set of attribute values. For example, a pattern may be recognized that has differing conclusions or actions for the same set of attribute values. The method of the present invention chooses a dominant action, or one occurring with the greatest frequency for a given pattern, as the normal or intelligent response for that pattern. Choosing the dominant action out of a group of actions for a particular set of attribute values has a statistical impact on the data.

One of the problems with choosing the dominant action from among those in the data is the potential loss of statistically small amounts of relevant data. If statistically small amounts of data are of particular interest, other steps can be taken to ensure capture of the desired data. For example, if fraud in a transaction is of interest, the instances of conclusions or actions related to non-fraudulent transactions may greatly outnumber the conclusions or actions related to fraud.

In fact, there may many orders of magnitude difference in the numbers of one conclusion (non-fraud) and the opposing conclusion (fraud). Given a probability of error for an improper conclusion, if the number of cases of interest are small enough in comparison to the number of overall cases, the expected number of erroneous cases may hide a significant pattern (to detect fraud).

For N overall examples containing n examples of fraud at a naturally occurring frequency, the overall probability of fraud=n/N. As a simplified example, if there are eight binary valued attributes, then there can be 256 different patterns. Say only 4 of the patterns truly represent fraud. If we assume the rest of the patterns are possible, the number of fraud examples may be over whelmed by erroneous non-fraud examples, if the probability of error, Pₑ, is sufficiently large. Assuming an even distribution of examples over all the patterns, then a non-fraud example containing attribute errors mimicking a fraud example will occur sufficiently often to overshadow the fraud conclusion if ((N-n)/(256-4))Pe>n/4. If N=10⁶, and n=10, then erroneous conclusions or actions which appear to be fraud will compete strongly with correct conclusions or actions if pₑ>63 10⁻⁵.

To avoid the above problem, the relationship between non-fraud examples and fraud examples must be more balanced. One way to overcome the problem is to reduce the number of non-fraud examples, and/or increase the number of fraud examples, n. With the number of instances of each conclusion or action occurring in roughly comparable numbers, the examples of interest will occur significantly more often than the erroneous examples. Modifying the selection of data to include more examples of interest and/or to decrease the instances of other conclusions does not change the intelligence content of the data. While a particular portion of the data is given more focus, the underlying data and attendant information remains unchanged.

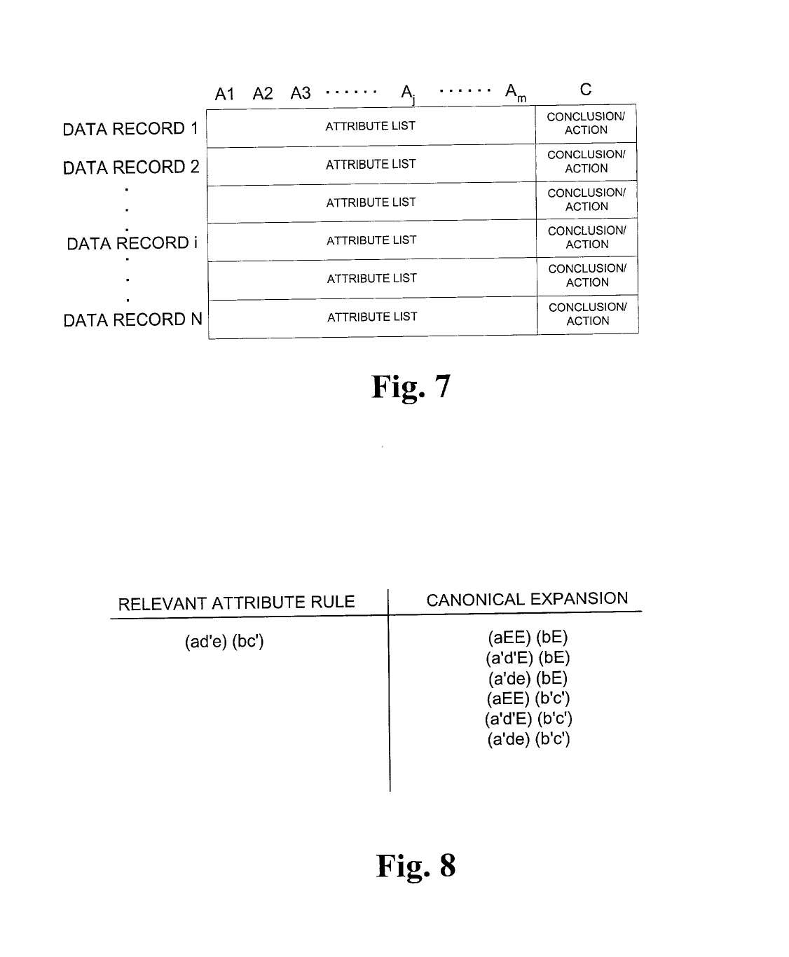

Each record consisting of a set of attributes and a conclusion or action is considered to be a rule. The set of data records comprise all the available rules and are essentially of the logical true/false form “If Attribute Value1 and Attribute Value2 and . . . and Attribute ValueN are present, then the Conclusion/Action is ActionA” (see FIG. 7). Attribute values need not be strictly true/false, and can take on other types of values, for example, a range.

Each data record is pruned to remove attributes that do not contribute to distinguishing the data record or rule, from other data records, or rules, having a different Conclusion/Action. The attributes which are pruned have their values essentially set to “Don't Care”. Once pruned, the rule becomes more general. The attributes which are pruned are referred to as “irrelevant”.

Once the attributes are pruned, there are usually some redundant rules. These duplicate rules are deleted. An attribute that can have more than two values will normally have only one of those values in the original rule formed from the data. However, rules can be combined to simplify the representation of the data, in which case attributes with more than two possible values can be combined for similar rules. The attributes with values numbering greater than two in this case can be represented with an “or” in the above logical form. The result is a set of rules giving complete domain coverage, but may include “or” terms as well as “and” terms. The combination of terms may be expanded into rules having just “and” terms (canonical form).

Any situations not provided by the data records are arbitrarily covered by the pruned rules and may cause more than one rule to be true when a new situation is encountered. These conflicts between rules in a new situation can be revealed to a domain expert during the design process, who can decide what the proper conclusion/action should be. The final result will be a complete and consistent rule set.

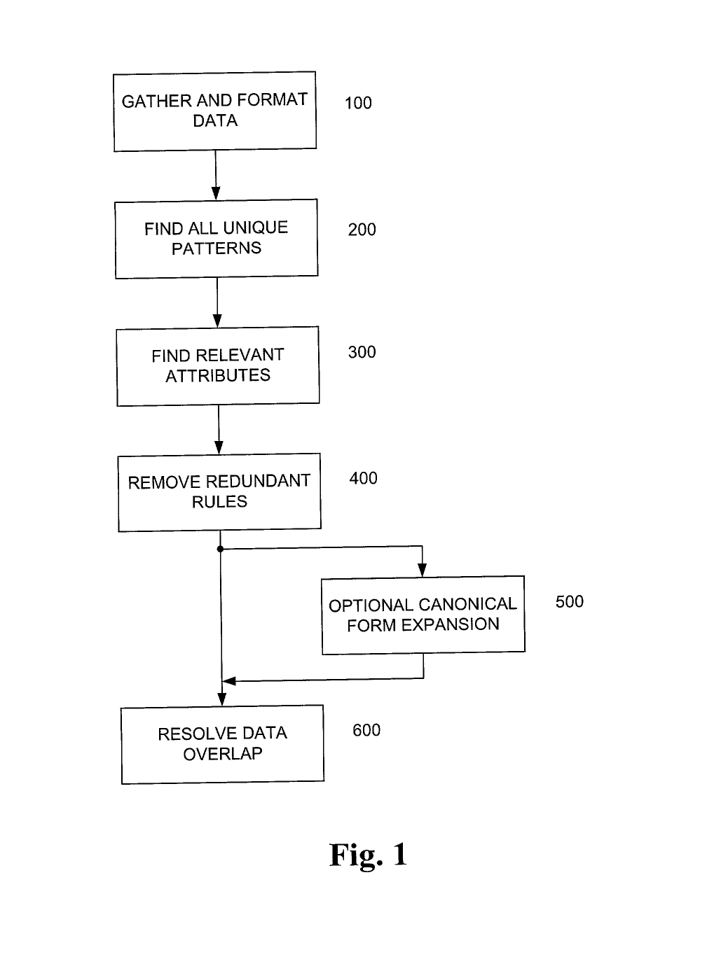

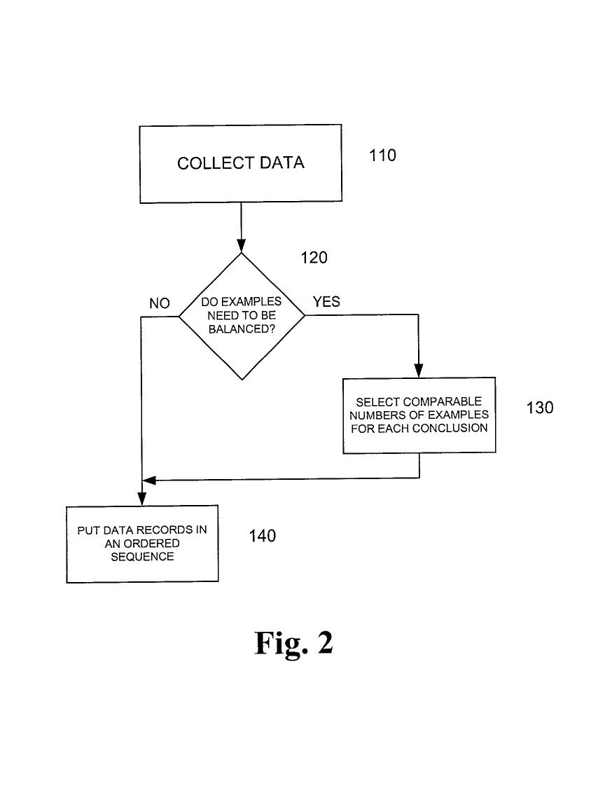

Referring now to FIG. 1, a method according to the present invention is shown. A first data gathering and formatting step 100 organizes the situation data. Referring for a moment to FIG. 2, formatting step 100 can include balancing steps 120, 130 to balance the data to accommodate statistically small occurrences within the data, as discussed above. An ordinary step 140 can be used to organize the data to take advantage of any facets of the data which would lead to more efficient application of the method of the invention.

A consolidation step 200 finds all unique patterns represented in the organized data. Each record will be treated as a rule with attribute values and conclusions/actions until it may be eliminated by consolidation with records having matching attribute values.

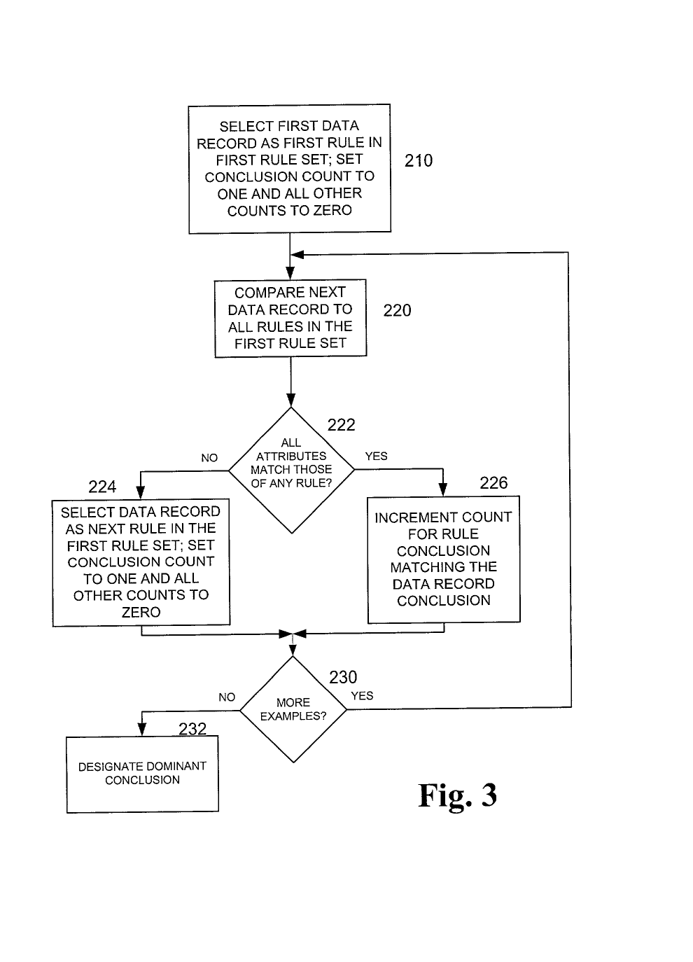

Referring to FIG. 3, the attribute values and conclusion/action in the first data record are designated as a first rule in step 210, and placed in a first rule set, which is initially empty. A space is set aside in the first rule set that is associated with the first rule, which can be used to store further conclusions/actions for the first rule.

The attribute values in the next data record are then compared to the corresponding attribute values in the first rule in step 220. If all the attribute values match exactly with those of the first rule in step 222, the record's conclusion/action is added to the first rule's conclusion/action list in the previously set aside space in step 226. If the conclusion/action for the data record is the same as one already in the first rule's conclusion/action list, a count for that conclusion/action is simply incremented.

If there is not an exact match between all of the attribute values of the first rule and the data record in step 222, a new, second rule is made from the data record and placed in the first rule set in step 224. The compared data record, including the attribute values and the conclusion/action of the data record, becomes the second rule. Again, a space is set aside for the second rule which can be used to store further conclusions/actions for the second rule.

The process of matching attributes of data records to rules is repeated for all the data records in step 230. Each data record is compared to each of the rules accumulated to that point. Data records with attribute values that match none of the accumulated rules are used to form new rules. Data records with attribute values that match those of a rule already accumulated have their conclusion/action added to those of the matching rule. Comparing each data record to the accumulated rules continues until from step 222:

a) a match is found for the data record being compared to the set of rules, in which case the data record's conclusion/action is added to the matched rule's conclusion/action list in step 226. If the conclusion/action is the same as one already present in the list for the matching rule, the count for that conclusion/action is merely incremented. or:

b) a comparison between the data record and all the rules accommodated to that point produce no match, in which case a new rule is made from the attribute values and associated conclusion/action of the data record in step 224.

In each case, after either matching the data record to a rule, or creating a new rule, a new data record is selected for processing. This sequence continues until all of the data records organized from step 100 are processed. The processing of all the data records results in a number of rules with unique patterns of attribute values and multiple conclusions/actions associated therewith. In keeping with the presumption that the dominant conclusion/action is the normal or correct response, all other conclusions/actions for a particular set of attribute values are discarded in step 232. The result is a set of rules generally much smaller in number than the number of data records, with each rule having a unique attribute value pattern with an associated conclusion/action.

It should be noted that if no action has a greater count than all other actions in a rule's action list, there is an insufficient number of relevant attributes in the rule (or too few data records), and no conclusion can be reliably designated in step 232. This difficulty can be reported to the person developing the rule set as a warning to obtain more attributes (or records). By default, one of the actions with the maximum count can be selected in step 232, or the dominant action assigned “inconclusive”, in order to proceed. Alternatively, a ratio of the largest action count to the next largest count can be required to be greater than 1 (e.g. 1.5, 2, 10) in order to designate an action as dominant. Otherwise, a warning is issued or the designation “inconclusive” is assigned.

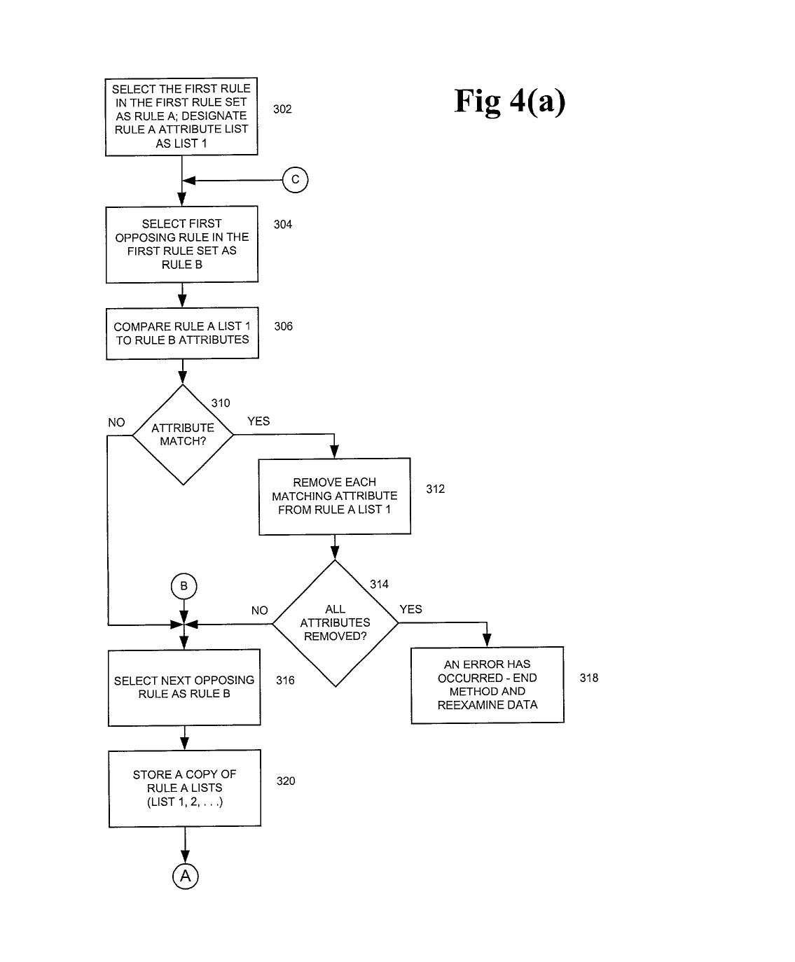

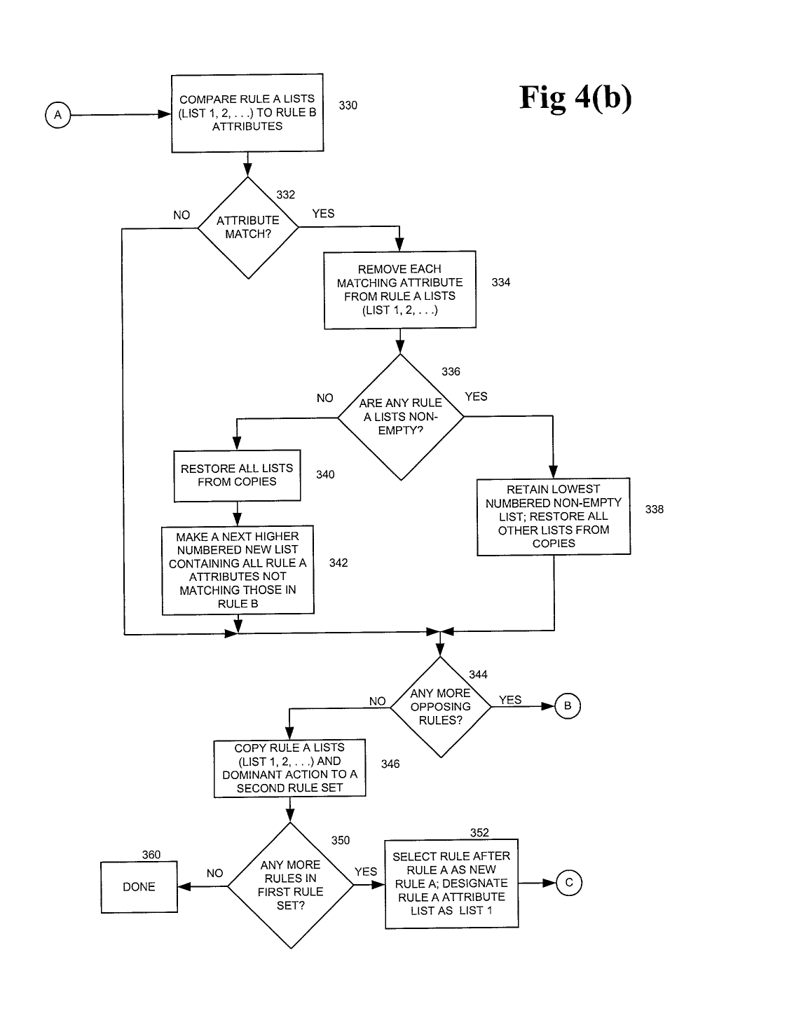

Once all of the data records are processed in step 200 the next step is to determine all of the relevant attributes in the set of resulting rules in step 300 (FIG. 1). Referring now to FIG. 4(a), the relevant attributes can be discovered when the rules are compared to each other with respect to a different dominant action. The procedure begins by selecting the first rule as a basis for comparison in step 302. An opposing rule, which is a rule that has a different dominant action, is then selected for comparison in step 304. The opposing rule is located using a sequential scan through the set of rules beginning with the first rule in the set. The comparison of the first rule and the opposing rule begins with the formation of an attribute list, call it List 1, that is formed with all of the attributes contained in the first rule. Each attribute value in List 1 is compared to the corresponding attribute values in the opposing rule in step 306.

As List 1 is compared to the attribute values of the opposing rule, any matches between attributes results in that attribute being removed from List 1 in step 312. Matching attributes between the rules having different dominant actions are removed because the same attribute values between rules do not contribute to differentiating the rules with respect to having different dominant actions. That is to say, based on the data, the removed attributes are not relevant to the rules. When removing attributes from List 1 through comparison to the opposing rule, at least one attribute will remain in List 1 because the previous process only creates a rule when there is an attribute value mismatch. Thus, at least one attribute in List 1 differs from its corresponding attribute of the opposing rule to which it is compared, or else there is an error as noted in step 318. List 1 has the potentially relevant attributes for the first rule, and is retained in its reduced form for further comparisons.

A second and subsequent comparisons are made in step 330 (FIG. 4(b)) between the first rule and another opposing rule. In step 316 another opposing rule having a different dominant action than that of the first rule is found and a copy of List 1, as potentially reduced from the initial comparison, is set aside in step 320.

The second comparison removes further attributes from List 1 that have values which match those of corresponding attributes in the compared opposing rule. The result will fall into two categories according to step 336:

1) At least one attribute remains in List 1 after comparing attributes with those of the second opposing rule and removing attributes that match. List 1, as reduced, is retained for further comparisons and the copy of the old List 1 is discarded;

or:

2) All attributes in List 1 are removed because each attribute value remaining in List 1 from previous comparisons and removals now matches the values of the corresponding attributes in the second opposing rule. In this situation, the values of the attributes remaining in List 1 match all the values of the corresponding attributes in the second opposing rule, and are thus removed from List 1. Since no attributes remain in List 1, no further comparisons can be made. List 1 is thus reinstated from the saved copy in step 340, and the attributes from the first rule not found in List 1 (List 1's complement from the first rule attributes) are placed into another List with a new sequential number, i.e., List 2. The attribute values of List 2 are then compared to the attribute values of the second opposing rule, and any matching attributes are removed from List 2. Again, the removed attributes represent information that is not relevant to differentiating the first rule from those rules with differing dominant conclusions. As discussed above, there will be at least one attribute in List 2 that does not match a corresponding attribute in the second opposing rule. Lists 1 and 2, as reduced, are retained for the subsequent comparisons against further opposing rules. Note that an attribute that appears in List 1 does not appear in List 2, and vice-versa.

In the third and subsequent comparisons, the Lists comprising attributes taken from the first rule are each then compared to a third and subsequent opposing rules, each time setting aside a copy of the Lists maintained to that point in step 320, i.e., List 1, List 2, etc.

If at least one attribute remains in any List after comparison with an opposing rule and removal of matching attributes in steps 330, 334, the lowest numbered non-empty List is retained in step 338. The copy of the retained list made in step 320 is discarded. The other Lists of attributes are restored from their copies for further comparisons with subsequent opposing rules.

If all the Lists become empty by removal of matching attribute values, the Lists are all restored from their copies in step 340. A new List, e.g., List 3, is formed from the attributes remaining in the first rule in step 342, presuming that the previous new list formed is List 2. The new List 3 represents the attributes not present in any of the other Lists. In addition, attributes are removed from List 3 that have values which match corresponding attribute values in the opposing rule under comparison. Again note that no attribute appears in more than one List, and at least one attribute will be in the new List 3.

When the first rule and all of the Lists comprising the rule's attributes have been compared to all opposing rules, only relevant attributes will remain in the Lists of the first rule. The List(s) are retained, along with the first rule's dominant action, as rule 1 of a second set of rules in step 346. This second rule set having relevant attributes in the rules is referred to as the set of relevant attribute rules.

The above process of comparing attributes and attribute Lists is repeated for the second and subsequent rules of the first rule set as shown in step 352. Taking the second rule, for instance, a comparison is made against all other opposing rules to extract List(s) for the second rule, as was done with the first rule in the first rule set. The resulting List(s) of relevant attributes and the associated dominant action form a relevant attribute rule that is added to the second rule set as rule 2. In the same way, the second rule set will accumulate a rule 3, and so on, until all rules in the first rule set have been selected and compared against all other opposing rules in the first rule set to produce relevant attribute rules for each of the rules in the first rule set. In making the comparison between opposing rules, the order of rule comparison is not critical.

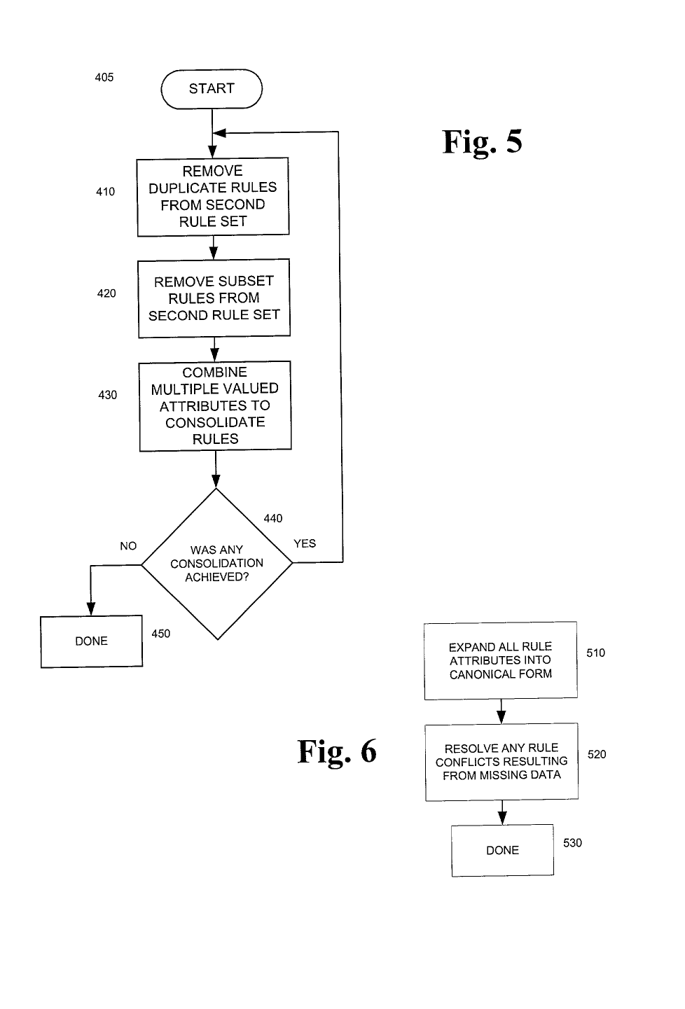

Referring now to FIG. 5, the next sequence in the data mining method removes redundant rules from the second rule set. Taking the second rule set and starting with the first relevant attribute rule, redundant relevant attribute rules are removed in step 410.

Special consideration is given to relevant attribute rules that have attributes which can take on multiple (more than two) values. If multiple valued attributes are present in separate relevant attribute rules that have the same conclusion/action, the relevant attribute rules can be consolidated by grouping attribute values. Grouping of multiple value attribute values can be done if all other attributes are identical in the two relevant attribute rules. For example, if an attribute “c” can have multiple values, two rules with the attributes (abc) having the same conclusion/action can be combined into one rule if attribute values for attributes “a” and “b” are identical. If attribute “c” has values “c₁” and “c₂” for the two rules, respectively, the two rules can be replaced by one rule, (abc), where attribute “c” has a value group of “c₁ or c₂”.

Redundant relevant attribute rules are removed by comparing the List(s) of relevant attribute values (or value groups determined in the previous process). The List(s) are compared to corresponding attribute value List(s) (or value groups) in relevant attribute rules with the same dominant action. If an attribute List in a relevant attribute rule contains more than one attribute, then consider that list a super set List. A subset List of the super set List contains fewer attributes of the super set List, where all the subset attribute values match corresponding attribute values in the super set List.

A List is also a subset List if all of its attribute values match those of a super set List, including one or more multiple valued attributes that contain a subset of values of those in value groups of the corresponding attributes in the super set List.

If every List in both rules completely match, one of the rules is deleted, since it is merely redundant. If one rule is a subset of the other, it is deleted in step 420 because it contains subset List(s) and no mismatched Lists, while the retained rule contains superset List(s) and no mismatched or subset Lists.

It may be necessary or helpful to break rules down into rule subsets to uncover subset redundancies. Referring to FIG. 8 for example, two Lists with relevant variables a, b, c, d and e permits the formation of a minimum of six rule subsets containing list subsets, where E represents “either” (the variable value is irrelevant) and a′=“not a”.

For List 1, (a d′ e), taking arbitrarily one of the relevant attributes, such as “a”, a list subset with “a” included can be indifferent with respect to “d” or “e”, or simply, (a E E). The next list subset that can be formed from these attributes which is exclusive of the first list subset is found by taking the complement of the attribute “a” selected for the first list subset, and including a further relevant attribute, hence (a′ d′ E). Taking the same approach to expand for a third relevant attribute results in the list subset (a′ d e). Each of these list subsets are mutually exclusive, and represent List 1 in expanded form. The process is repeated for List 2, (b c′), and the expansion of List 1 associated with each list subset of List 2, (b E) and (b′c′), to form six mutually exclusive rules in canonical form.

When all List(s) for each relevant attribute rule have been thus expanded, rule subset redundancy can be directly seen as exactly matching rules. Some rearranging of attributes may be needed e.g., sets (a E E) and (a′ d′ E) may have to be rearranged by splitting (a E E) into (a d E) and (a d′ E), and combining (a′ d′ E) with (a d′ E). This choice results in the logical combinations: (E d′ E) and (a d E). Similarly, List(s) containing attribute values that are subsets of their corresponding attribute value groups (for multiple valued attributes) require expansion of the encompassing sets if the subsets are not confined to just one of the two rules.

If a relevant attribute rule contains List(s) that exactly match another relevant attribute rule with the same conclusion/action, except that one List differs by one non-binary (multiple valued) attribute value (or value group), then the two relevant attribute rules can be combined. One of the two relevant attribute rules is selected and the single value (or value group) by which the other relevant attribute rule is different is added to the group of the selected relevant attribute rule. If the single value (or values within the group) is a duplicate of the selected relevant attribute rule, the single value (or duplicate values within the group) is not added. Once this combined relevant attribute rule is created, the other relevant attribute rule is discarded. When comparing attributes with more than one value (a value group), a match can only be obtained when all values of the group match.

When the first relevant attribute rule and its attribute List(s) have been compared to all other rules having the same conclusion/action, the process is repeated for the second and subsequent surviving relevant attribute rules in steps 410, 420 and 430. Each of the second and subsequent surviving relevant attribute rules is compared to the corresponding attribute List(s) of every other relevant attribute rule having the same dominant conclusion/action as its own. Note that when the second rule is compared to the first rule, the first rule can be significantly different from when it was first compared to the second rule, since it may have some attributes deleted and may have acquired attribute value groups.

Because the rules are modified in the previous redundancy removal, the above process must be repeated until no further consolidation occurs (step 440). At the point where no further consolidation occurs, all redundancies have been removed (step 450).

Referring now to FIG. 6, the surviving relevant attribute rule List(s) may be optionally expanded into canonical form in step 510, starting with the first surviving relevant attribute rule. Any surviving relevant attribute rule having List(s) containing more than one attribute may be expanded into rule subsets as described above. This expansion produces a complete and consistent set of rules for the decision space defined by the data records, if all condition combinations have been covered by the data records. Missing data condition combinations will manifest themselves as overlapping rules (inconsistent). In step 520, data can be sought to resolve the overlaps, or a person with domain expertise can rationalize which rules are valid and discard the invalid rules. Canonical expansion can alternatively be performed prior to removal of redundant relevant attribute rules (step 410), possibly simplifying the processing of redundancies.

Note that the order of data records and rules are unimportant, therefore the procedures above may process the rules in a different order to increase program performance or provide other benefits. For example, a processing order which compares the first rule to the last and work forward to the second rule may provide certain benefits. For the processes including finding relevant attributes and beyond, a change in order can result in different, but equally valid rules, when the data records do not cover all significant cases.

The first steps of comparing attribute values to build the first rule set guarantees that every pattern in the data is represented by a rule once and only once. This process usually produces too many rules to be useful because not all of the attributes are relevant to the conclusion in a rule. Different values of the irrelevant attributes force these steps to generate extra rules for the same conclusion/action.

The process of finding relevant attribute rules determines which attributes are irrelevant for each rule generated in the previous steps. The process results in a separate, relevant attribute rule for each of the rules of the first rule set. The extraction of relevant attribute rules is accomplished by forming lists of attributes that are relevant in differentiating the various rules with respect to conclusions/actions. Separate attribute Lists, each containing a portion of all of the attributes for a particular rule, are formed within the relevant attribute rule. The formation of the List(s) serves to differentiate subsets of rules that have different conclusions/actions. No attribute is contained in more than one list within the rule. Attributes that do not contribute to differentiating the relevant attribute rule from other rules with opposing conclusions/actions are removed from the list. All attributes not removed in the extraction of relevant attribute rules are the relevant attributes that characterize the situation of the original data record, and thus warrant the associated dominant conclusion/action. It may be possible to extend the absolute knowledge contained in the data that defines the dominant conclusions/actions using human input to correct rules that have no predominant actions or to develop potentially missing rules.

Once the relevant attribute rules are extracted, redundant relevant attribute rules are removed. Relevant attributes that can have more than two values have their values grouped, when two of this type of relevant attribute rules have the same dominant action, and are redundant in all other ways. Attributes with binary values cannot be further generalized by grouping. A pruned set of relevant attribute rules is built by removing relevant attribute rules having the same dominant action, and having identical values for each of the corresponding relevant attributes or having just one mismatched multi-valued attribute that has values which are combined into a group.

The optional canonical expansion puts the surviving relevant attribute rules into a logical “and” form. The relevant attribute rules that have Lists of relevant attributes with more than one relevant attribute per List represent a logical “and”, “or” form. In either form, this method only guarantees that the rules do not conflict with the given data records. The rules, however, may conflict with each other if an insufficient set of data records is used to describe the particular situation they are meant to represent. Overlap of rules with different actions signifies the need for human intervention to make up for the lack of information in the data records. An expert can examine the rule set, identify overlap and correct any conflict to reduce the rule set to a consistent set that completely covers, but does not over-cover the decision space defined by the number of attribute values.

It should be noted that it is not necessary to track or store counts for each attribute value according to the method of the present invention. The reduction in required storage provides a significant advantage over some statistical methods that must track and count each attribute value. The present method only requires tracking and counting of the conclusions. Since the number of attributes can be much greater than the number of conclusions, the savings can be significant. The count of attribute values can be implied from the count of conclusions, since the conclusion count for a rule is only incremented if all the rule's attributes exactly match the example to which it is being compared. This implication loses validity only if an attribute's value is not known, and all values are assumed to be present for that example. Such treatment creates multiple examples, one for each possible value of the attribute with unknown value. The validity of the implication can be improved by permitting the attribute to assume the legitimate value of “UNKNOWN” as one of its possible values. This approach will add one extra rule to the rule set, instead of a single rule for each possible value for the attribute.

It is possible to store pointers to conclusions and counts for each pointer instead of storing a count for each possible conclusion for each rule. For example, eight (8) pointer-count pairs can accommodate many conclusions if the incidence of erroneous conclusions is very small. The dominant conclusion and a few erroneous conclusions would be stored for each rule with a reasonably small storage space.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for formulating a set of rules representing a situation, comprising:
finding within a collection of data related to said situation a representative collection of data comprising attribute patterns and associated conclusions;
forming said set of rules by:
a) comparing a selected attribute pattern to all other attribute patterns associated with conclusions different than that of said selected attribute pattern in said representative collection to match irrelevant attribute elements between said selected attribute pattern and said compared attribute patterns;
b) removing said irrelevant attribute elements from said selected attribute pattern; and
repeating a) and b) for each attribute pattern in said representative collection.

2. A method for formulating a set of rules according to claim 1, further comprising removing redundant rules from said set of rules.

3. A method for formulating a set of rules according to claim 1, wherein said collection of data can be chosen to increase the relative occurrence of an infrequently occurring association between a subset of said attribute patterns and said associated conclusions.

4. A method for formulating a set of rules according to claim 1, wherein:
finding said representative collection includes:
forming said representative collection with an initial attribute pattern and an associated conclusion indication drawn from said collection of data;
selecting another attribute pattern from said collection of data;
a) selecting another attribute pattern from said collection of data;
b) comparing said selected attribute pattern with all attribute patterns in said representative collection;
c) adding said selected attribute pattern and an associated conclusion indication to said representative collection if said selected attribute pattern matches none of said attribute patterns in said representative collection;
d) adding a conclusion indication associated with said selected attribute pattern to an associated conclusion indication of a matching attribute pattern in said representative collection; and
repeating a) through d) until all attribute patterns in said collection of data are exhausted.

5. A method for formulating a set of rules according to claim 4, further comprising choosing a representative conclusion for each of said attribute patterns in said representative collection by identifying a predominant conclusion based on said associated conclusion indication.

6. A method for formulating a set of rules according to claim 4, further comprising selecting a representative conclusion for at least one of said attribute patterns in said representative collection based on relevant knowledge about said collection of data.

7. A method for formulating a set of rules according to claim 4, wherein said associated conclusion indication contains associated conclusions.

8. A method for formulating a set of rules according to claim 4, wherein said associated conclusion indication contains associated conclusion counts.

9. A method for formulating a set of rules according to claim 2, wherein each rule in said set of rules is expanded into a canonical form before removing said redundant rules.

10. A system for formulating a set of rules representing a situation, comprising:
a storage media containing a set of data records related to said situation;
each of said data records includes an attribute pattern and an associated conclusion;
a processor operable to manipulate said set of data records to form a representative collection of attribute patterns and associated conclusions storable on said storage media;
said processor being further operable to manipulate said representative collection to remove attribute elements from each of said attribute patterns that are irrelevant to said associated conclusions to form a set of rules storable on said storage media; and
said processor is further operable to remove redundant ones of said rules from said set of rules to provide a complete and consistent rule set.

11. A system for formulating a set of rules according to claim 10, further comprising:
a sample space including said set of data records;
said processor being operable to select said set of data records from said sample space to increase a relative occurrence frequency of an infrequently occurring situation.

12. A system for formulating a set of rules according to claim 10, wherein:
said storage media contains at least one attribute pattern associated with a plurality of conclusions; and
said processor is operable to select a single conclusion as a representative conclusion from said plurality based on a specified criteria.

13. A system for formulating a set of rules according to claim 12, wherein said specified criteria is provided by an expert.

14. A system for formulating a set of rules according to claim 10, wherein said processor is operable to expand said set of rules into a canonical form before said redundant ones of said rules are removed.

15. A system for formulating a set of rules according to claim 10, wherein:
said manipulation of said representative collection includes:
a comparator module coupled to said processor and operable to provide a comparison between a selected attribute pattern and all other attribute patterns having conclusions different than that of said selected attribute pattern; and
said processor is further operable to identify said irrelevant attribute elements in said selected attribute pattern as selected attribute elements that match attribute elements in said all other attribute patterns.

16. A computer readable memory storing a program code executable to form a set of rules representing a situation, said program code comprising:
a first code section executable to find within a collection of data related to said situation a representative collection of data comprising attribute patterns and associated conclusions;
a second code section executable to compare a selected attribute pattern to all other attribute patterns associated with conclusions different than that of said selected attribute pattern in said representative collection to match irrelevant attribute elements between said selected attribute pattern and said compared attribute patterns;
a third code section executable to remove said irrelevant attribute elements from said selected attribute pattern; and
a fourth code section containing logic executable to repeat said second and third code sections for each attribute pattern to form a set of rules.

17. A program code according to claim 16, further comprising a fifth code section executable to remove redundant rules from said set of rules.

18. A network of interconnected computers storing program code and data for forming a set of rules representing a situation, comprising:
a storage media coupled to said network and containing a set of data records related to said situation;
each of said data records includes an attribute pattern and an associated conclusion;
a processor coupled to said network and operable to manipulate said set of data records to form a representative collection of attribute patterns and associated conclusions storable on said storage media;
said processor being further operable to manipulate said representative collection to remove attribute elements from each of said attribute patterns that are irrelevant to said associated conclusions to form a set of rules storable on said storage media; and
said processor is further operable to remove redundant ones of said rules from said set of rules to provide a complete and consistent rule set.

19. A method for forming a set of rules representing a situation, comprising:
finding all non-redundant fact patterns related to said situation in a data set;
identifying at least one attribute in each fact pattern that contributes to a respective conclusion associated with said fact pattern; and
forming said set of rules using said identified attributes and said respective associated conclusions.

20. A method according to claim 19, further comprising removing redundancies within said set of rules.

21. A method for forming a set of rules according to claim 19, wherein said data set consists of a set of records being selected to have a first conclusion in a reduced ratio with respect to a second conclusion.

22. A method for forming a set of rules according to claim 19, wherein:
each said fact pattern is associated with a group of conclusions; and
said method further comprises selecting a single conclusion from each of said groups as said respective associated conclusion.

23. A method for forming a set of rules according to claim 20, wherein said rules are expanded into a canonical form prior to removing redundancies.

24. A carrier medium containing a program code executable to form a set of rules representing a situation, said program code comprising:
a first code section executable to find within a collection of data related to said situation a representative collection of data comprising attribute patterns and associated conclusions;
a second code section executable to compare a selected attribute pattern to all other attribute patterns associated with conclusions different than that of said selected attribute pattern in said representative collection to match irrelevant attribute elements between said selected attribute pattern and said compared attribute patterns;
a third code section executable to remove said irrelevant attribute elements from said selected attribute pattern; and
a fourth code section containing logic executable to repeat said second and third code sections for each attribute pattern to form a set of rules.

25. A processor operable to execute a program code from a storage memory, said program code comprising:
a first code section executable to find, within a collection of data related to a situation, a representative collection of data comprising attribute patterns and associated conclusions;
a second code section executable to compare a selected attribute pattern to all other attribute patterns associated with conclusions different than that of said selected attribute pattern in said representative collection to match irrelevant attribute elements between said selected attribute pattern and said compared attribute patterns;
a third code section executable to remove said irrelevant attribute elements from said selected attribute pattern;
a fourth code section containing logic executable to repeat said second and third code sections for each attribute pattern to form a set of rules; and
a fifth code section executable to remove redundant rules from said set of rules.

26. A method for formulating a set of rules representing a situation, comprising:
obtaining a set of data records related to said situation, each data record containing a set of attributes and an associated conclusion;
forming a first set of mutually exclusive attribute patterns from said data records, each attribute pattern being associated with a respective conclusion group containing at least one conclusion;
maintaining a count of data records associated each conclusion in each respective conclusion group;
forming a second set of attribute patterns from said first set, each attribute pattern in said second set being associated with a preferred conclusion chosen from said respective associated conclusion group, said attribute patterns in said second set containing attributes relevant to said situation, said second set of attribute patterns being formed by:
a) creating in said second set a copy of a selected attribute pattern with an associated preferred conclusion from said first set;
b) comparing said copied selected attribute pattern to all other attribute patterns in said first set having associated preferred conclusions different from said associated preferred conclusion of said copied selected attribute pattern thereby identifying any attributes of said copied selected attribute pattern that are irrelevant to said situation;
c) removing said irrelevant attributes from said copied selected attribute pattern in said second set; and
repeating a), b) and c) for each attribute pattern in said first set to form said second set of attribute patterns comprising said set of rules.

27. A method for formulating a set of rules representing a situation according to claim 26, further comprising:
choosing as said set of data records a subset of data records from all available data records to increase a relative occurrence of an infrequently occurring conclusion.

28. A method for formulating a set of rules representing a situation, comprising:
obtaining a set of data records, each data record containing a set of attributes forming an attribute pattern and an associated conclusion;
forming from said set of data records a first set of mutually exclusive attribute patterns each associated with a conclusion group containing at least one conclusion, said first set of attribute patterns being formed by:
a) placing a copy of an initial attribute pattern and an initial associated conclusion from an initial data record into said first set of attribute patterns, said initial associated conclusion being placed in a conclusion group in said first set of attribute patterns, and initializing a first conclusion count for said initial associated conclusion placed in said first conclusion group;
b) reading an attribute pattern and an associated conclusion from a selected data record;
c) comparing said read attribute pattern to all attribute patterns of said first set of attribute patterns;
d) if said read attribute pattern matches none of said first set of attribute patterns, adding said read attribute pattern and said read associated conclusion from said selected data record into said first set of attribute patterns, said read associated conclusion being placed in another conclusion group associated with said read attribute pattern added to said first set of attribute patterns, and initializing another conclusion count for said read associated conclusion in said another associated conclusion group;
e) if a match between said read attribute pattern and said first set of attribute patterns is found and if said read associated conclusion is already in a conclusion group associated with said matched attribute pattern in said first set of attribute patterns, incrementing a conclusion count for said read associated conclusion in said conclusion group associated with said matched attribute pattern, and if said read associated conclusion is not already in said conclusion group associated with said matched attribute pattern, adding said read associated conclusion to said conclusion group associated with said matched attribute pattern and initializing a conclusion count for said added read associated conclusion;
f) selecting another data record and reading an attribute pattern and an associated conclusion from said selected data record; and repeating c) through f) until all attribute patterns for said set of data records are exhausted;
selecting a representative conclusion from each of said conclusion groups as a preferred conclusion based on criteria including said conclusion counts;
forming a second set of attribute patterns, each associated with respective preferred conclusions, said attribute patterns in said second set containing attributes relative to said situation, said second set of attribute patterns being formed by:
g) placing a copy of a selected attribute pattern and said associated preferred conclusion from said first set of attribute patterns into said second set of attribute patterns and comparing said copied selected attribute pattern to all other attribute patterns in said first set of attribute patterns having associated preferred conclusions different from said associated preferred conclusion of said copied selected attribute pattern thereby identifying any attributes of said copied selected attribute pattern that are irrelevant to said situation;
h) removing said irrelevant attributes from said copied selected attribute pattern in said second set; and
repeating g) and h) for each attribute pattern in said first set of attribute patterns to form said second set of attribute patterns, said second set of attribute patterns and associated preferred conclusions forming said set of rules.

29. A method for formulating a set of rules according to claim 26, wherein said preferred conclusion for each of said attribute patterns is chosen by identifying a predominant conclusion based on said count of data records.

30. A method for formulating a set of rules according to claim 26, wherein at least one of said preferred conclusions is chosen based on relevant knowledge.
